(19) United States
(12) Patent Application Publication
(10) Pub. No.: US 2021/0047858 A1
(43) Pub. Date: Feb. 18, 2021

(54) POST POUNDER

(71) Applicant: Blount, Inc., Portland, OR (US)

(72) Inventors: Robert Castell, Portland, OR (US); Juxin Zhang Harley, Portland, OR (US)

(21) Appl. No.: 16/779,370

(22) Filed: Jan. 31, 2020

Related U.S. Application Data
(60) Provisional application No. 62/886,955, filed on Aug. 14, 2019.

(51) Int. Cl. E04H 17/26

(52) U.S. Cl. CPC E04H 17/263

(57) ABSTRACT

A post pounder with a delta handle configuration and reinforced plug is disclosed. In embodiments, a post pounder includes a hollow tubular body where one end is closed with a plug. Two opposing handles are formed to the body of the post pounder by attaching a rod to a hollow tubular body at a first point, passing the rod over the plugged end of the body, and attaching the rod to the body at a second point opposed to the first point. In some embodiments, a bend is formed in the rod in each of the handles to provide a delta configuration.

### CROSS-REFERENCE TO RELATED APPLICATION

This application claims the priority benefit of the earlier filing date of U.S. Provisional Application No. 62/886,955, filed Aug. 14, 2019, which is hereby incorporated herein by reference in its entirety.

### TECHNICAL FIELD

The present disclosure relates to the field of hand tools, and specifically to a device for installing and manually driving a post into a substrate, such as the ground.

### BACKGROUND

When installing posts, stakes, poles, and similar elongated structures (collectively, “posts”), such structures typically need to be driven into a substrate to a depth sufficient to ensure stable placement. Generally, the deeper a post is driven into the substrate, the more stable it will be. Harder and/or denser substrates such as day and soil, while potentially offering greater support (and thus, stability) compared to softer substrates such as sand and gravel, pose a greater resistance into driving the post to the necessary depth. Where a substrate offers substantial resistance, the installer may turn to mechanical assistance to achieve the necessary depth. For smaller posts, such as rods or stages, a mallet (typically weighing a few pounds at most) may provide sufficient mass and driving power. For larger posts, a post pounder may be employed, which can be manually driven or powered. Manual post pounders typically weigh over 10 pounds for basic small models, and are available in increasing weights to accommodate larger posts. Manual post pounders are typically manipulated by hand for positioning, with the mass of the post pounder in conjunction with gravity helping to provide the driving force. A post pounder with sufficient mass can be effective at driving comparatively larger posts through dense substrates.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings.

FIG. 1 illustrates a first example post pounder, according to various embodiments.

FIG. 2 is an overhead view of the example post pounder depicted in FIG. 1, according to various embodiments.

FIGS. 3 and 4 illustrate different bars for reinforcing a plug, such as the plug on the example post pounder of FIG. 1, according to various embodiments.

FIG. 5 illustrates a second example post pounder, according to various embodiments.

FIG. 6 illustrates an example end plug that may be used with a post pounder, such as the example post pounders of FIG. 1 or FIG. 5, according to various embodiments.

FIG. 7 illustrates an example weight ring that may be used with a post pounder, such as the example post pounders of FIG. 1 or FIG. 5, according to various embodiments.

### DETAILED DESCRIPTION OF DISCLOSED EMBODIMENTS

In the following detailed description, reference is made to the accompanying figures which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical contact with each other. “Coupled” may mean that two or more elements are in direct physical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

Manual post pounders are typically implemented as hand tools. A manual, or hand-driven, post pounder is essentially a hollow tube equipped with a pair of handles that extend from the tube sides in an opposing fashion. In a common configuration, the tube is open at one end, and sealed at the opposing end. The tube and/or handles may be weighted to achieve a desired mass to facilitate driving posts. In use, the post driver is first placed over the top of a post to be driven. The top portion of the post inserts into the hollow tube via the open end. Holding onto each handle, the user then repeatedly lifts the post pounder, and forcibly brings it down upon the post. The sealed end of the tube thereby strikes the top of the post, and so imparts energy from the momentum of the post driver to the post, repeatedly driving the post into the substrate. By keeping the post within the hollow tube, the blows from the post pounder are focused upon the top of the post and imparted in a direction substantially along the longitudinal axis of the post. The diameter of the hollow tube determines the maximum size of post that can be driven by a given post pounder, while the mass of the post pounder determines how hard a substrate into which the post pounder can drive a post (provided the post can absorb the blows without excessive deformation), with higher mass post pounders capable of delivering more powerful blows and so driving into denser substrates.

Each handle of a currently available typical post pounder is attached to the side of the tubular body of the pounder at two attachment points, spaced apart longitudinally. The handles are typically disposed on the body so as to oppose each other, e.g. each handle is positioned 180 degrees from the other where the body is substantially circular in cross-section, or on opposed sides where the body is square in cross-section. Each handle typically has a main portion that runs substantially parallel to the longitudinal axis of the post pounder, but spaced apart from the body a distance at least sufficient to accommodate the fingers of a user. Other currently available post pounders may slightly angle the main portion of each handle relative to the longitudinal axis, so that each handle is spaced further from the body at one attachment point compared to the other attachment point. In either implementation, the pair of handles typically provides a relatively narrow grip, which may not provide optimal ergonomics. As a result, the grip may cause relatively rapid operator fatigue in use, due to poor use of chest and/or arm muscles. The onset of fatigue, in turn, reduces potential productivity of the operator, especially in settings where multiple posts must be driven. Further still, the narrow grip may render the post pounder awkward to use where the post is relatively short or tall relative to the operator, due to the operator being forced into unusual angles. Finally, particularly where the pair of handles are oriented substantially parallel to the sides of the body, the operator's grip may be prone to slipping during use, reducing controllability and potentially reducing the force of impact that the operator may be able to impart with the pounder.

In another aspect, the closed end of the hollow tube is an impact surface, which acts as the interface where energy is imparted from the post pounder to the post being driven. As such, it bears the majority of wear, and is subject to the greatest stresses while in use. Existing post pounders are typically constructed from a hollow tube, with a plug or cap affixed to one end of the tube to close it and form the impact surface. The handles may be welded or otherwise attached to the exterior side of the tube. The nature by which the plug or cap is attached to the tube can impact the longevity and performance of the post pounder. For example, caps that are press-fit may not be capable of withstanding the same level of force as a cap that is welded in place. Even with a cap that is welded in place and is of a relatively substantial thickness, the weld may only penetrate a fraction of an inch, with the weld depth ultimately defining the longevity of the post pounder, as the weld is required to absorb the full force of each impact. With use over time, the weld or other attachment means that secures the plug or other attachment means in place may weaken and ultimately fail. If the attachment means fails, the end plug may become dislodged, allowing the post to pass entirely through the post pounder, rendering the post pounder useless.

Embodiments disclosed herein provide a post pounder that offers a grip with improved ergonomics, and/or reinforces the end plug or closing means by use of the handle structure. Disclosed embodiments form the handle from a single bar, rod, or shaft, which is attached at one end on a side of the hollow body, passed over the closed end of the body, and secured at a second end on the opposing side of the hollow body. By passing the bar over the closed end, the bar acts as a reinforcing structure to retain the plug or other closing means with a greater strength than is possible if the plug or closing means is simply welded or otherwise attached with another attachment means to the body. Further, the bar may be shaped into an approximately delta shape, with the handles angled away from the body. The angled handles offer a wider, more ergonomic grip that can decrease slippage, offering an operator a more comfortable grip that potentially yields better use of chest and arm muscles. This delta geometry thus results in less fatigue to the operator, potentially an improved imparting of impact force, and easier/more comfortable use of the post pounder on posts of widely varying heights. Consequently, operator productivity can be enhanced.

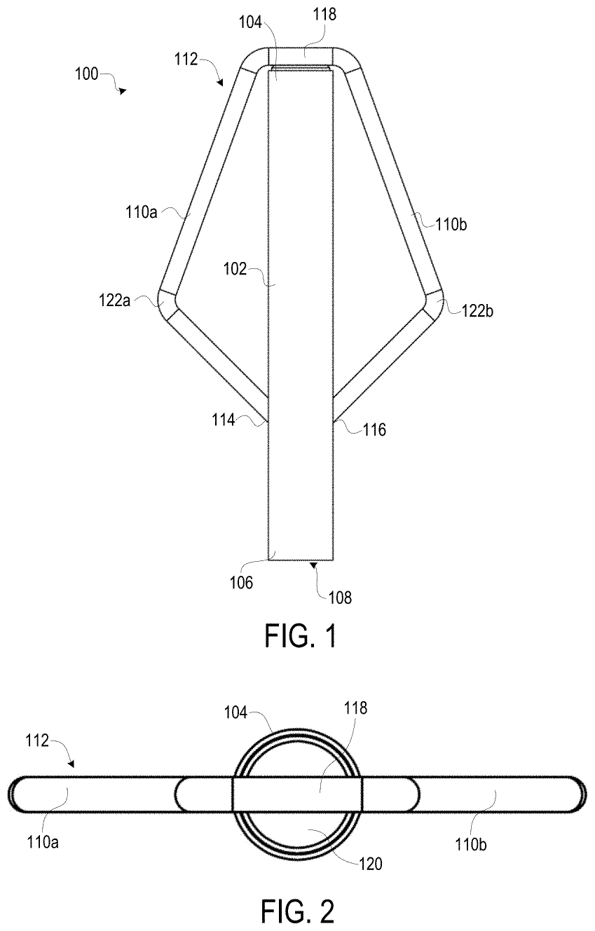

FIG. 1 discloses an example post pounder 100, according to some embodiments. Post pounder 100 includes a body 102 with a first end 104 and a second end 106. While first end 104 is closed in the depicted embodiment, second end 106 is open to allow communication with the hollow interior space 108 contained within body 102. A plurality of handles 110a, 110b (generically, 110) are formed from a single bar or rod 112, which in turn is secured to the body 102 at first point 114 and second point 116. The rod 112, in embodiments, is configured to pass over the first end 104, thereby securing and/or reinforcing the end cap or plug 120.

Body 102, in embodiments, is constructed from an elongated tube, such as a pipe. Body 102 may have a round or substantially circular cross-section, a polygonal cross-section, e.g. triangular, square, pentagonal, hexagonal, etc., or a cross-section of an arbitrary shape, as may be appropriate for an intended use of the post pounder 100. As will be understood, the size of body 102 at least partially determines the sorts of materials with which a given embodiment of a post pounder 100 may be used. The wall of body 102 may be of a suitable thickness to obtain a desired durability and overall weight. Further, body 102 may be constructed from a material that is suitably durable for a given use. In some embodiments, body 102 may be constructed from a durable metal, such as iron or steel, or another suitable alloy, or another suitable material such as a plastic or a composite. As with the wall thickness, the wall material may be selected to obtain a desired weight, with the material and thickness of the wall of body 102 being the primary factors in determining the overall weight of post pounder 100. In other embodiments, post pounder 100 may be fitted with material specifically to achieve a desired weight. It will be understood that a heavier post pounder 100 may be able to impart more forceful blows upon a post being driven, at the expense of requiring a greater exertion by the user.

Body 102, defining a longitudinal axis, includes a first end 104 and a second end 106, distally located from first end 104. The length of body 102, defined as the distance between first end 104 and second end 106, may be selected with respect to the intended use of post pounder 100. In some embodiments, the length of body 102 is sufficient to allow a typical user to effect sufficiently powerful blows against a post to be driven without having to lift the post pounder 100 fully above the post being driven (where second end 106 clears the post being driven), e.g. at all times during use, a portion of the post being driven is enclosed within body 102.

First end 104 may include a plug 120 or other closing means, while second end 106 is open to allow access to interior space 108, for insertion of a post or pole to be driven by post pounder 100. Plug 120, in embodiments, comprises the primary impact surface of post pounder 100, which directly imparts the force of blows to a post that is being driven. Plug 120 may be constructed from a plate of similar thickness and material as the wall of body 102, e.g. a steel plate, or may be constructed of a different material, or material of a different thickness, as may be appropriate for a given use of post pounder 100. In some embodiments, plug 120 may be thicker or otherwise reinforced to withstand absorbing the repeated blows imparted while post pounder 100 is in use. Further, plug 120 may be used to help achieve a desired weight of post pounder 100.

Plug 120 may be secured to first end 104 of body 102, in some embodiments, using a suitable technique such as welding, brazing, soldering, press-fitting, or any other technique that secures plug 120 so that it can withstand impacts to a post being driven as well as transfer the energy of each impact from the post pounder 100 to the post. In other embodiments, plug 120 may be formed as an integral part of body 102. Plug 120, in embodiments, is further secured via rod 112, as will be discussed herein. In still further embodiments, plug 120 may be omitted, and rod 112 may form the primary impact surface of post pounder 100. Still further, plug 120 may be formed integral with rod 112.

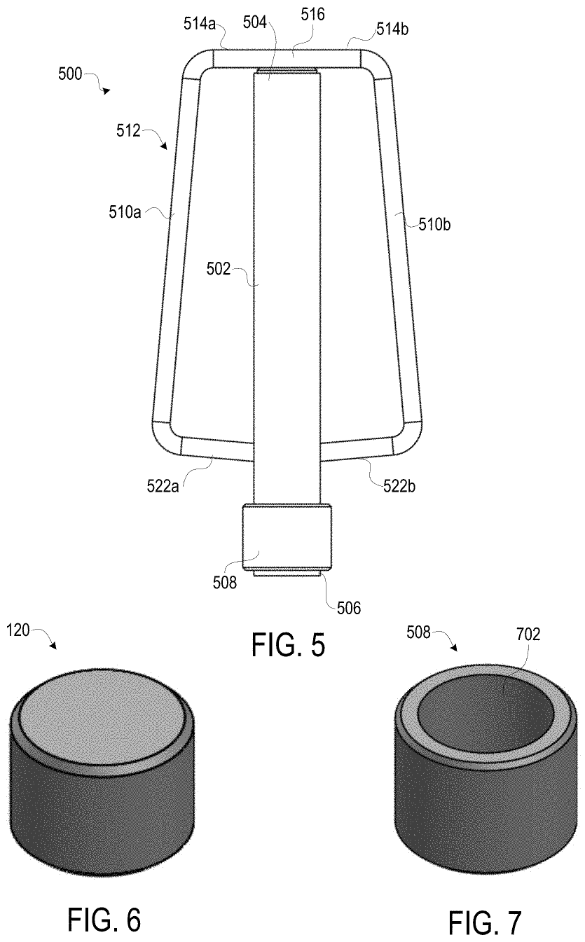

An example embodiment of a plug 120 is depicted in FIG. 6. In the embodiments depicted in FIGS. 1 and 5 (discussed below), the plug 120 is sized to fit within the inside diameter of body 102. In such embodiments, plug 120 may comprise a solid billet of material. In addition to providing a sturdy internal impact surface, a solid plug 120 may act as a weight to increase the mass of the post pounder 100, thus increasing the possible amount of energy that post pounder 100 may impart to a post being driven. In some embodiments, plug 120 may be wholly or partially hollow, depending upon the requirements of a given post pounder implementation. If hollow or partially hollow, the interior cavity of plug 120 may be sized or shaped to facilitate driving a post. In other embodiments, plug 120 may be sized to fit around the exterior diameter of body 102. As will be understood, in such embodiments plug 120 would be hollow at one end, to receive an end of body 102. Plug 120 may then be welded, brazed, or otherwise suitably secured to the exterior of body 102, or may be sized to press-fit, and rely upon rod 112 for retention. In still other embodiments, plug 120 may be solid apart from a groove machined into one end of the plug 120 (not illustrated), sized to accommodate the width of the wall of body 102. In such a configuration, body 102 can insert into the groove, allowing plug 102 to secure to the exterior of body 102 while also providing the benefits of a substantially solid plug 102 discussed above, e.g. greater weight and a solid striking surface.

Attached to either side of body 102, in the depicted embodiment, are handles 110a and 110b (non-specifically referred to as handle 110). Each handle 110a and 110b includes a respective bend 122a and 122b (non-specifically referred to as bend 122), so as to divide each handle 110 into two segments separated by an angle, with each bend 122 forming a point at which each handle 110 is furthest away from body 102. As a result, each handle 110, in embodiments, provides two differently angled gripping surfaces, which further can be gripped near to the body 102 when gripped near either first end 104 or second end 106, or further from the body 102 when gripped near bend 122. This varying spacing allows users of different sizes to readily find a gripping distance that feels natural, allowing for extend use of the post pounder 100 without significant fatigue. Further, the presence of bend 122 results in each portion angling away from body 102, presenting a handle angle that is more ergonomic to grip, e.g. more closely follows the natural gripping angle of a user, whether gripped overhand or underhand. Post pounder 100 can thus be gripped with either an overhand grip by grabbing the section of each handle 110a and 110b that is proximate to first end 104, or an underhand grip by grabbing the section of each handle 110a and 110b that is proximate to second end 106. As will be understood, the relative angles of each handle section can be varied by changing the location of bend 122 along the longitudinal axis of body 102, e.g. moving it more proximate to either first end 104 or second end 106, while keeping the distance of bend 122 to body 102 constant. Alternatively, the angles of each section can be altered by varying the distance of bend 122 to body 102 while keeping the longitudinal location of bend 122 fixed.

Handles 110a and 110b, as can be seen, are formed from a single rod 112, in some embodiments. In such embodiments, rod 112 is attached to body 102 at the first point 114 and second point 116, and is formed by creating bends 122a and 122b, as well as by passing rod 112 closely over first end 104. Thus, a portion 118 of rod 112 is passed over plug 120, thus providing structural reinforcement for the plug 120, in addition or alternatively to how plug 120 may be attached to body 102, described above. Portion 118 can thus act to absorb at least a portion of each impact imparted by post pounder 100, and/or reinforce the attachment of plug 120 to body 102. In some embodiments, plug 120 may be secured to portion 118, such as by welding, brazing, soldering, or another suitable attachment technique. When so secured to portion 118, plug 120 may not need to be secured or attached to body 102, with rod 112 acting to hold plug 120 in place and absorb impacts from use of the post pounder 100. In some embodiments, handles 110a and 110b may be formed from a plurality of separate pieces that may be subsequently joined, such as by welding, soldering, brazing, or another suitable joining technique.

Referring to FIG. 2, the first end 104 of post pounder 100 is depicted, illustrating the arrangement of portion 118 of rod 112 with respect to plug 120. As can be seen in the embodiment in FIG. 2, portion 118 passes over approximately the center of plug 120 as well as body 102, to provide structural reinforcement of plug 120. This additional structural reinforcement to plug 120 can improve the overall longevity of post pounder 100, and/or allow the amount of impact force that post pounder 100 can impart without receiving appreciable damage to be increased. As can be seen, the profile/cross-section of portion 118 does not vary from the overall cross-section of rod 112. In other embodiments, portion 118 may be configured with a different cross-section from rod 112, potentially to enhance the structural reinforcement of plug 120. For example, portion 118 could be configured with a greater thickness than rod 112, or to cover a greater portion of plug 120 than would otherwise be covered by the normal cross-section of rod 112, to enhance support of plug 120.

As can also be seen in FIG. 2, each of the handles 110 in the depicted embodiment is disposed 180 degrees from the other handle, e.g. on opposite sides of body 102. In other embodiments, the handles 110 may be disposed from each other at an angle lesser than 180 degrees, to potentially provide a different ergonomic grip geometry. In some embodiments, the handles 110 may be disposed from each other at an angle between 180 degrees and 90 degrees. In still other embodiments, the handles 110 may be disposed from each other at an angle less than 90 degrees. In still other embodiments, post pounder 100 may be equipped with more than two handles, potentially to offer a range of different positions by which post pounder 100 may be gripped and manipulated.

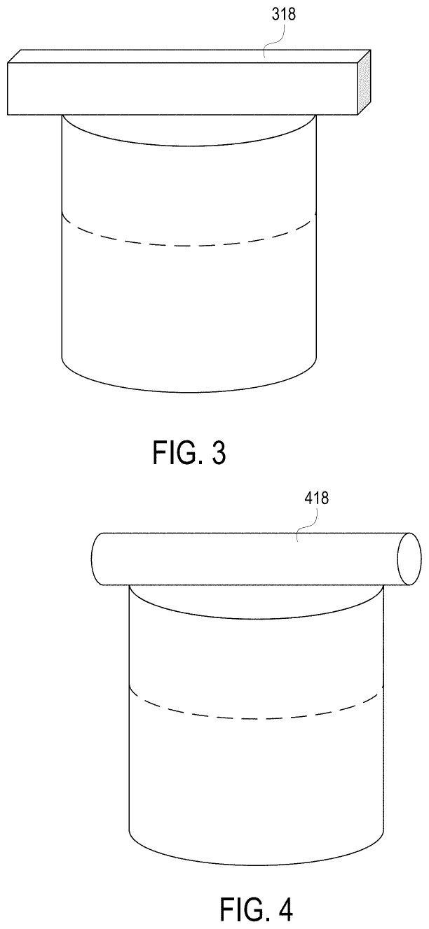

Turning to FIGS. 3 and 4, two different cross sections of a portion of a handle rod covering a plug are depicted. In FIG. 3, portion 318 is shown with a square cross-section. A square cross-section can offer a relatively broad swath in contact with a plug in the end of the body, and so may enhance structural rigidity. In FIG. 4, portion 418 is shown with a round cross-section, more representative of the cross section of a typical rod 112. It will be appreciated that a square cross-section may not be ideal for the portions of rod 112 that form each handle 110, as the corners of a square cross-section may be uncomfortable for a user of a post pounder. Thus, portion 318 may be formed from a round cross-section rod, thus providing a relatively comfortable grip for the handles 110a and 110b, while providing enhanced contact and structural support against the plug. Where a round cross-section nevertheless offers sufficient support, such as portion 418, a round cross-section may be preferable from a manufacturing perspective, as it does not require modification of the rod forming the handles, and can be easily achieved via bending a single piece rod. It will further be understood that FIGS. 3 and 4 depict only two possible cross-sections for the portion supporting the plug. Other cross-sections are possible, that may offer various advantages, e.g. a triangular cross-section may offer both a relatively broad contact area against a plug, while also offering a greater resistance against bending or warping (which may result from use of the post pounder) than a square cross-section. Other cross-sections may be possible.

FIG. 5 depicts a second possible embodiment of the post pounder, post pounder 500. Similar to post pounder 100, post pounder 500 includes a body 502 with a first end 504 and a second end 506. As with post pounder 100, first end 504 is closed in the depicted embodiment, and second end 506 is open to allow communication with the hollow interior space contained within body 502. A plurality of handles 510a, 510b (generically, 510) are formed from the single bar or rod 512, which in turn is secured to the body 502 at two points, similar to post pounder 100. The rod 512, in embodiments, is configured with a segment 516 that passes over the first end 504 to secure and/or reinforce the end cap or plug 120, as discussed above with respect to FIGS. 2 and 6.

In distinction from post pounder 100, the rod 512 is bent and shaped to orient each handle 510 in a relatively more parallel fashion relative to body 502, albeit with a slight angle in the depicted embodiment. The bends closest to the second end 506 approach 90 degrees, to form second handles 522a and 522b (generically, 522) that extend nearly perpendicular away from body 502. In this configuration, each handle 522 can be readily gripped either overhand or underhand, depending upon the user's preference. The orientation of handles 522 may vary depending upon the needs of a given embodiment. While in the depicted embodiment handles 522 are angled slightly towards the first end 504 and away from second end 506, in some embodiments, handles 522 may be oriented slightly towards second end 506, and away from first end 504. As will be understood, such configurations may be achieved by altering the angle at which rod 512 is bent to form handles 510 and handles 522.

Rod 512 also is bent to form handles 510 further away from first end 504 as compared to post pounder 100. This greater distance allows for the formation of third handles 514a and 514b (generically, 514). In the depicted embodiment, handles 514 extend perpendicular away from the longitudinal axis of body 502. Other embodiments may angle handles 514 towards or away from body 502, such as by curving or bending the portion of rod 512 that runs across the first end 504. Handles 514 provide an additional position to be gripped either overhand or underhand. The formation of handles 514 can facilitate use of post pounder 500 for driving relatively low-height posts (e.g. below an operator's waist) by allowing post pounder 500 to be manipulated from its top. In such a position, a user would otherwise likely have to crouch, bend over, or sit to use post pounder 500 with handles 510, which could lead to discomfort at best, and possibly injury. Further, the provision of handles 514 at the top of post pounder 500 allows post pounder 500 to be manipulated with the bulk of its weight suspended below the handles 514, which some users may find easier, depending upon the weight of post pounder 500.

As can be seen in FIG. 5, the example post pounder 500 further includes a weight 508 secured proximate to its second end 506. A possible embodiment of weight 508 is depicted separately in FIG. 7. Weight 508 is essentially ring-shaped, with a center bore 702 sized to be closely received over the exterior of body 502. Body 502 is inserted through bore 702, and weight 508 may thus be secured to body 502 via any suitable method, such as welding, brazing, soldering, or another suitable attachment method. Alternatively or additionally, in some embodiments, weight 508 may be press fit into place. Weight 508 may be sized to be retained around body 502 via friction, and may be installed by heating weight 508 and/or cooling body 502, with the expansion/contraction of the metals of weight 508 and/or body 502 resulting in a tight friction fit as temperatures equalize. In some embodiments, weight 508 may be formed as a part of and be integral with body 502. In other embodiments, weight 508 may be sized to fit inside of body 502, provided that bore 702 is able to be adequately sized to accommodate materials to be driven by post pounder 500. While weight 508 is depicted as a ring, weight 508 may be of different shapes, e.g. square or another polygon, and may differ in shape from body 502. For example, body 502 may be round while weight 508 may be square, with bore 702 shaped as round to accommodate body 502. For another example, body 502 may be square or oval in cross-section with bore 702 shaped to match, while the exterior of weight 508 may be a different shape, e.g. round or polygonal.

Weight 508, in embodiments, may be constructed from the same materials as body 502. In other embodiments, weight 508 may be constructed from a different material, such as a material selected to achieve a desired weight and balance for post pounder. Possible materials may include steel, aluminum, lead, copper, titanium, or another suitable metal, ceramic, concrete, plastic, or any other suitable material.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways.

This application is intended to cover any adaptations or variations of the embodiments discussed herein. Therefore, it is manifestly intended that embodiments be limited only by the claims and the equivalents thereof.

The invention that is claimed is:

1. A post pounder, comprising:
a hollow body with an interior space, a first end that is open so that a post can be received within the interior space, and a second end that is closed; and
a plurality of handles disposed upon an exterior surface of the hollow body;
wherein the plurality of handles are formed from a rod that is secured at a first point on the exterior surface, passed across the second end, and secured at a second point on the exterior surface.

2. The post pounder of claim 1, wherein the rod is affixed to the second end.

3. The post pounder of claim 1, wherein the second end is closed with a plug that is welded to the second end and to the rod.

4. The post pounder of claim 1, wherein the body is comprised of a tube, and the first point and second point are disposed at approximately the same distance along the body between the first and second ends.

5. The post pounder of claim 4, wherein the first point and second point are disposed at radially opposed points on the body.

6. The post pounder of claim 4, wherein the first and second point are disposed at points that are radially offset between 90 degrees and 180 degrees.

7. The post pounder of claim 1, wherein the rod has a round cross-section.

8. The post pounder of claim 7, wherein the second end is closed with a plug, and a portion of the rod passes over the plug.

9. The post pounder of claim 8, wherein the portion of the rod that passes over the plug has a square cross-section.

10. The post pounder of claim 8, wherein the plug is formed as part of the portion of the rod.

11. The post pounder of claim 1, wherein each of the plurality of handles comprises a bend that defines two first handle portions and two second handle portions, each handle portion diverging angularly away from the body toward the bend.

12. The post pounder of claim 11, wherein each of the plurality of handles comprises a second bend that defines two third handle portions, the third handle portions proximate to the second end.

13. The post pounder of claim 1, further comprising a weight secured proximate to the first end.

14. A method for constructing a post pounder, comprising:
providing a hollow tubular body with a sidewall, a first end and a second end;
attaching a first end of a rod to the sidewall at a first point;
passing the rod over the first end; and
attaching a second end of the rod to the sidewall at a second point distal from the first point.

15. The method of claim 14, further comprising securing a plug to the first end of the body, within the first end and beneath the rod.

16. The method of claim 15, further comprising welding the plug to the rod.

17. The method of claim 14, further comprising forming a first bend in the rod between the first point and the first end, and forming a second bend in the rod between the second point and the first end.
